(19) United States
(12) Patent Application Publication
(10) Pub. No.: US 2014/0354688 A1
(43) Pub. Date: Dec. 4, 2014

(54) AUGMENTED REALITY INFORMATION PROVIDING APPARATUS AND METHOD

(71) Applicant: Korea Electronics Technology Institute, Gyeonggi-do (KR)

(72) Inventors: Kyung Won MIN, Seongnam-si (KR); Haeng Seon SON, Seongnam-si (KR); Seon Young LEE, Seoul (KR)

(73) Assignee: Korea Electronics Technology Institute, Gyeonggi-do (KR)

(21) Appl. No.: 14/066,812

(22) Filed: Oct. 30, 2013

(30) Foreign Application Priority Data
May 31, 2013 (KR) 10-2013-0062946

(51) Int. Cl. G06T 19/00; G06F 3/01

(52) U.S. Cl. CPC G06T 19/006; G06F 3/013
USPC 345/633

(57) ABSTRACT

Provided are an apparatus and method for providing augmented reality information using a glasses-type wearable device or head mount display. The present invention may provide augmented reality information generated by overlaying POI information in a gaze direction of a user on an image in the direction. Also, the present invention may compare main POI with an object in the image to adjust position information of the user when providing the augmented reality information, thereby providing the augmented reality information having high visibility and accuracy, with the size of UI being adjusted according to the distance from the user. The present invention may allow the user to designate an object in the image by a 3D pointing operation of the user, thereby displaying more precise augmented reality information.

### CROSS-REFERENCE TO RELATED APPLICATIONS

This application claims priority under 35 U.S.C. §119 to Korean Patent Application No. 10-2013-0062946, filed on May 31, 2013, the disclosure of which is incorporated herein by reference in its entirety.

### TECHNICAL FIELD

The present invention relates to a glasses-type wearable device or head mount display, and more particularly, to an augmented reality information providing apparatus and method for providing an image of a point where a user is gazing and also information about a point of interest (POI) included in the image.

### BACKGROUND

The related art glasses-type wearable device or head mount display (HMD) is intended to deliver additional information in addition to a current image visually observed by a user, using a see-through information display apparatus.

Recently, efforts are being made to apply an augmented reality (AR) service for displaying information in addition to an actual image using a glasses-type wearable device or HMD.

In the related art augmented reality services using a smartphone, a user may acquire an image of a target augmentation region with a camera of the smartphone and overlay specific information inside/outside the image by using a feature point of an object. In more particular, a user may check his/her position using a GPS receiver, a gyro sensor, and an altitude sensor equipped in a device and then display ambient information using distance information indirectly measured by a monoscopic camera with respect to the position.

The display of this type augmented information is performed by mostly using GPS positioning information having a positioning error of several to tens of meters and a monoscopic camera capable of indirect distance measurement using a camera parameter, thereby significantly reducing a positioning precision of a wearer of the glasses-type device or head mount display, a point of interest (POI), and ambient information. As a result, there is a limitation in that three-dimensional (3D) augmented information about the POI or ambient information may not be precisely performed.

Furthermore, a main method for performing interaction using the glasses-type wearable device or HMD performs pointing-based user interaction using a bare hand or specific pointing device. For a device incapable of providing the distance information, it is possible only to perform 2D-planar interaction (that is, two-dimensional (2D) lateral motion), and thus it is difficult to effectively interact with a three-dimensionally overlapped object.

### SUMMARY

Accordingly, the present invention provides a glasses-type wearable device or HMD device equipped with a direct distance measurement sensor such as a stereovision and Time of Flight (TOF) providing a precise augmented service to a user and allowing the user to perform a gesture-based user interaction and a gyro sensor and an altitude sensor for measuring the user's gaze direction and height.

The present invention also provides a distance-based augmented reality service and 3D pointing-based user interaction method.

In one general aspect, an augmented reality information providing apparatus includes: a point of interest (POI) information search unit configured to acquire rough position information of a user on the basis of GPS and measure gaze direction information of the user on the basis of the rough position information to acquire information about a main POI; a distance information acquisition unit configured to acquire an image in a gaze direction of the user and acquire distance information to a main POI included in the image; a control unit configured to compare the main POI, correct the position information of the user on the basis of the position information of the main POI and the distance information between a glasses wearer and the main POI according to a result of the comparison, and provide the main POI and the information about the main POI; and a display unit configured to display the image provided by the distance information acquisition unit and the augmented reality information provided by the control unit.

The POI information search unit may acquire rough position information of the user using received GPS information and acquire the gaze direction and height information using a gyro sensor and an altitude sensor, and search for a position and a variety of characteristic information of the main POI stored in the storage unit inside the apparatus or acquire the position and the variety of characteristic information of the main POI from the external server through the communication unit on the basis of the position information of the user and the gaze direction and height information.

The distance information acquisition unit may include two cameras, or one camera and one TOF sensor.

The control unit may adjust the position information of the user using the position information of the main POI detected by the POI information search unit and the distance information between a glasses-type wearer and the main POI acquired by the distance information acquisition unit, when a feature point extracted in the image information acquired by the sensor is matched with a feature point of the main POI stored in a storage unit in the apparatus or stored in an external server.

The control unit may provide the augmented reality information having the adjusted size of the augmented information represented in the POI according to the distance information.

The control unit may recognize a pointing indicating the POI using a sensor equipped in the distance information acquisition unit, check whether the pointing is positioned within a certain region of the POI, and when the pointing is in a region (x, y) including an error of the POI, determine that the pointing indicates the POI if a distance index (z*a) obtained by multiplying the relative movement distance (z-axis direction) of the pointing gesture operation by a certain magnification (a) that is predetermined or determined by learning indicates the POI positioned at the real distance (Z) most similarly, and then provide the augmented information.

In another general aspect, an augmented reality information providing method includes: acquiring information such as position, form, etc. of the main POI positioned in a gaze direction of the user from an apparatus or a server connected to the apparatus through a wired/wireless communication network on the basis of GPS-based position information and gaze direction information of a user; acquiring an image in the gaze direction of the user; acquiring distance information to a variety of objects included in the image; comparing the objects and the main POI to adjust the point information of the user on the basis of the distance information according to a result of the comparison; and providing augmented reality information including POI information.

The adjusting of the position information of the user according to a result of the comparison may include if there exists a portion where the feature point of the main POI stored in a storage unit inside the apparatus or stored in the external server is matched with a feature point of the object included in an image input through the camera, determining the portion as the main POI, adjusting the position information of the user on the basis of the distance information between the glasses wearer (user) and the main POI, adjusting the size of the augmented reality information according to the distance between a variety of POIs (displayed on a GIS or map) and the objects (for example, smaller if remotely), and then displaying the adjusted augmented reality information.

The providing of augmented reality information including the POI information may include providing the augmented reality information including information about a pointing for indicating the POI; and checking whether the pointing is positioned within a certain region of the POI by using an image acquisition sensor attached to the apparatus such as a camera, determining that the pointing indicates the POI if a distance index (z*a) obtained by multiplying the relative movement distance (z-axis direction) of the pointing gesture operation by a certain magnification (a) that is predetermined or determined by learning indicates the POI positioned at the real distance (Z) most similarly, and then providing the augmented information.

Other features and aspects will be apparent from the following detailed description, the drawings, and the claims.

### BRIEF DESCRIPTION OF THE DRAWINGS

FIG. 1 is a block diagram showing an augmented reality information providing apparatus according to an embodiment of the present invention.

FIGS. 2 and 3 are views illustrating an example of the augmented reality information apparatus according to an embodiment of the present invention.

FIG. 4 is a flowchart showing an augmented reality information providing method according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

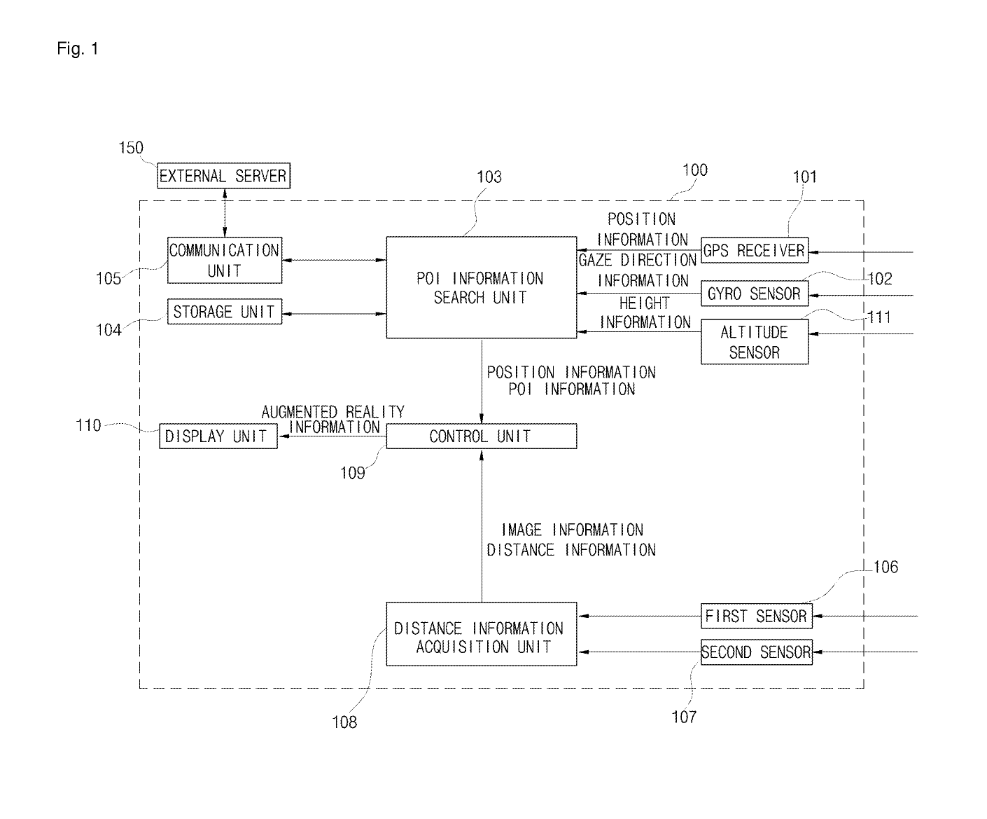

FIG. 1 is a block diagram showing an augmented reality information providing apparatus 100 according to an embodiment of the present invention.

The augmented reality information providing apparatus 100 according to an embodiment of the present invention includes a point of interest (POI) information search unit 103, a distance information acquisition unit 108, a control unit 109, and a display unit 110 as a basic configuration.

The POI information search unit 103 searches for and provides information about a point of interest (POI) positioned at a place where a user wearing the augmented reality information providing apparatus 100 is gazing.

The POI information search unit 103 receives the position information of the user from a GPS receiver 101 to recognize where the user is gazing, and receives information about a height of where the user is gazing and a gaze direction of the user from a gyro sensor 102 and an altitude sensor 111. Accordingly, the POI information search unit 103 acquires information about the current position of the user and the direction faced by the augmented reality information providing apparatus 100.

The POI information search unit 103 searches for information about a POI positioned where a user is gazing, on the basis of the user's position information and gaze direction information.

The POI information search unit 103 may search a storage unit 104 included inside the augmented reality information providing apparatus 100 to acquire information about the POI. Alternatively, the POI information search unit 103 may inquire of an external server 150, which stores POI information through a communication unit 105, to receive the POI information.

A method of searching for POI information through the storage unit 104 included inside the augmented reality information providing apparatus 100 has an advantage of fast searching speed, compared with a method of inquiring of the external server 150. However, the method of searching for POI information may have a limitation in that the POI information cannot be immediately updated. Thus, the method of inquiring of the external server 150 through the communication unit 105 may be used complementarily, and also the POI information stored in the storage unit 104 may be periodically updated on the basis of the POI information stored in the external server 150.

When acquiring POI information on the basis of the user's position information and gaze direction information, the POI information search unit 103 delivers the user's position information and the POI information to the control unit 109.

The distance information acquisition unit 108 acquires an image in a gaze direction of a user wearing the augmented reality information providing apparatus 100 and information about objects positioned in the image, and the information about the objects includes information about feature points of the objects and distance information to the objects.

The distance information acquisition unit 108 may acquire the image and information about objects from the first sensor 106 and the second sensor 107. The first sensor 106 and the second sensor 107 may each include a camera. Alternatively, one of the first sensor 106 and the second sensor 107 may include a camera, and the other may include a time of flight (TOF) sensor.

The distance information acquisition unit 108 may deliver the image information about where a user is gazing and the information about objects included in the image to the control unit 109.

The control unit 109 generates and provides augmented reality information on the basis of the image information delivered from the distance information acquisition unit 108 and the POI information delivered from the POI information search unit 103. That is, the control unit 109 provides the augmented reality information obtained by overlaying the image in a gaze direction of the user on the POI in the direction, and the present invention performs a user position correction process based on the delivered information in order to increase accuracy of the provided augmented reality information.

The control unit 109 compares the information about feature points delivered from the distance information acquisition unit 108 with a feature point of a main POI among the POIs provided from the POI information search unit 103.

Here, the main POI means a point including a position, feature information (information for recognition, such as a building image, building exterior information, etc.), and any other information (for example, a menu of bread, a store name, etc. in a case of a bread store), and the POI means a position including simple position information and any other information.

When a feature point of an object is matched with a feature point of a main POI over a predetermined level as a result of the comparison, it may be determined that the object is matched with the main POI.

The control unit 109 may check an objective position of the object from the position information of the main POI when checking the main POI matched with the object in the image. Since distance information from the user to the object is acquired, the current position information of the user may be inversely estimated by summing the information about the main POI and the distance information to the object.

The control unit 109 adjusts the position information of the user acquired through GPS on the basis of the estimated user position information and adjusts the gaze direction information and POI information of the user on the basis of the adjusted user position information.

The control unit 109 generates augmented reality information by overlaying the image information delivered from the distance information acquisition unit 108, on the adjusted POI information. The control unit 109 may adjust the size of the POI included in the augmented reality information such that the size may be displayed in inverse proportion to the distance from the current position of the user to the POI.

The control unit 109 displays the generated augmented reality information through the display unit 110 to the user. The display unit 110 may include a transparent display.

According to an embodiment of the present invention, the control unit 109 may provide the augmented reality information including a pointing for indicating the POI when providing the POI information. The pointing functions to provide the POI information (for example, the name, business type, etc. of the POI) when a user indicates the POI by using an object having a form capable of pointing to the specific position, such as a finger, an arrow, and a rod.

In this case, since the pointing may inaccurately indicate the POI, the control unit 109 converts relative distance movement of a variety of pointing devices (including a finger) according to the pointing operation into an actual distance to the POI, thereby easily finding the POI indicated by the user among a plurality of POIs positioned at different distances to definitely generate and provide the augmented reality information about the POI indicated by the user.

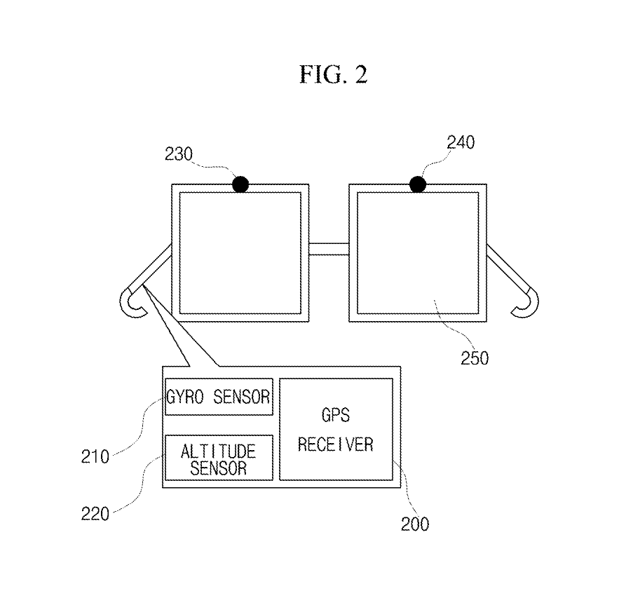

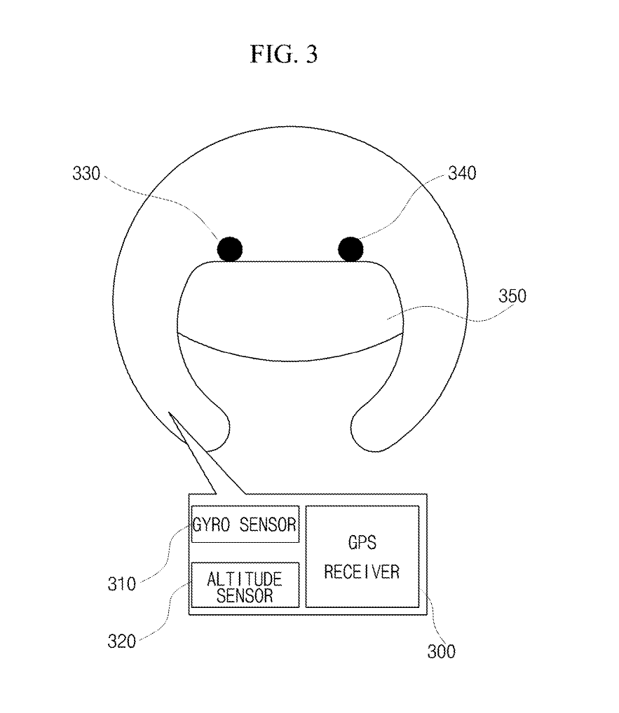

FIGS. 2 and 3 are views illustrating an example of the augmented reality information providing apparatus according to an embodiment of the present invention.

As shown in FIG. 2, the augmented reality information providing apparatus may include a glasses-type wearable device.

In this case, a GPS receiver 200, a gyro sensor 210, and an altitude sensor 220 may be positioned at a glasses frame, and first and second sensors 230 and 240 for acquiring an image and distance information to objects included in the image may be positioned at an edge of the transparent display 250 while facing the front.

As shown in FIG. 3, the augmented reality information providing apparatus may be configured as a head mount display.

A GPS receiver 300, a gyro sensor 310, and an altitude sensor 320 may be positioned at a side of the head mount display, and first and second sensors 330 and 340 are positioned on the top of the device while facing the front. The transparent display 350 may be positioned at a place where the user is gazing.

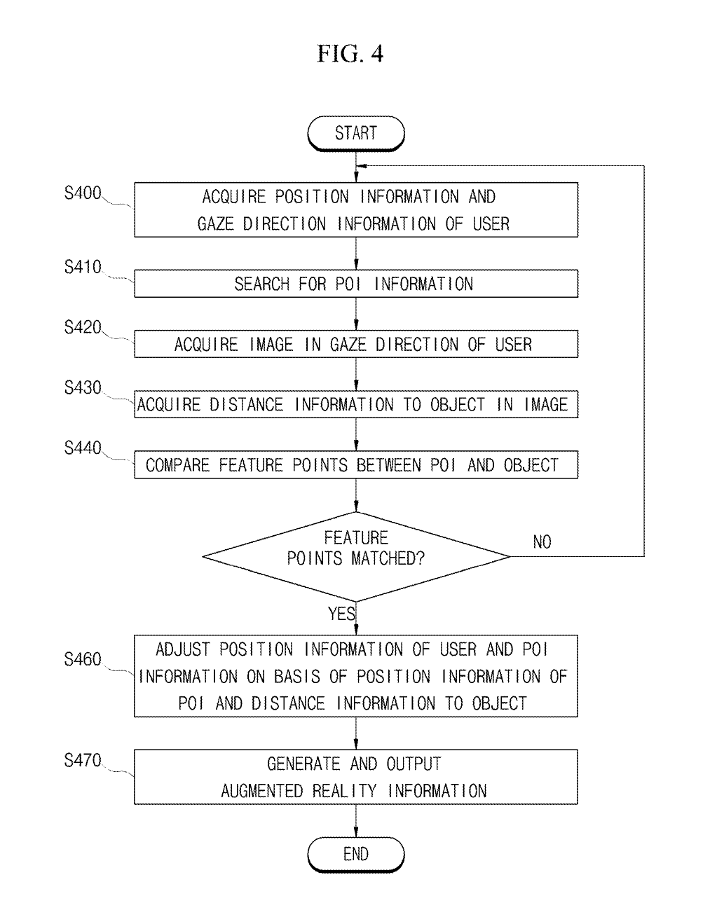

FIG. 4 is a flowchart showing a method of an augmented reality information providing method according to an embodiment of the present invention.

The augmented reality information providing apparatus acquires an image and POI information about a position where a user is gazing and then generates the augmented reality information.

The augmented reality information providing apparatus acquires the user's position information and gaze direction information in order to obtain POI information about a position where the user is gazing in operation S400. The user's position information may be acquired by receiving GPS signals, and the gaze direction information may be acquired using the gyro sensor and the altitude sensor and used to recognize a height, direction, etc. of the user's gaze.

The augmented reality information providing apparatus searches for information about a POI of the user's gaze when acquiring the current user's position and the information about a place where the user is gazing, in operation S410. In this case, the augmented reality information providing apparatus may search for the POI information stored in the augmented reality information providing apparatus or search for the information stored in an external server in communication with the external server.

The augmented reality information providing apparatus acquires an image of a position where a user is gazing from a camera, etc. in operation S420 and acquires information about objects included in the image from a camera or TOF sensor, including information about feature points of objects, information about distances to the objects, etc, in operation S430.

The augmented reality information providing apparatus performs a user position correction process in order to increase accuracy of information when generating the augmented reality information on the basis of the information.

The augmented reality information providing apparatus compares feature points of a main POI where the user is gazing with feature points of objects included in the image, in operation S440.

As a result of the comparison, if the feature points are matched in operation S450, the objects in the image may be determined to correspond to the main POI, and thus the current position of the user may be inversely calculated and then estimated on the basis of position information and distance information about a main POI stored previously. The augmented reality information providing apparatus compares position information of a user acquired through GPS with the estimated position information of the user in operation S460.

The augmented reality information providing apparatus generates augmented reality information that includes an image in the gaze direction of the user and information about the POI included in the image, and provides the augmented reality information to the user in operation S470.

The present invention may match distance information directly measured by a distance measurement sensor with 3D position information based on GPS, gyro, and altitude sensors to measure a precise 3D position of a specific object, thereby provide the augmented information to a glass wearer (user) more efficiently and precisely, when compared to a conventional method of detecting a rough position with GPS information, extracting 2D feature point with a monoscopic camera to recognize a specific object, and then providing augmented information about the object to a user wearing a glasses-type wearable device or HMD.

Also, the present invention represents UIs having different forms (sizes) according to distance information between a position of the user precisely measured through the above-mentioned process and a POI (a building or object (person, vehicle, etc)) measured with the distance sensor, and variably change the size of the UI using distance information with the POI, which increases/decreases as the user moves, allowing the user to easily find out the POI information according to the distance.

Also, the present invention may convert relative distance movement of a variety of pointing devices (including a finger) according to the pointing operation into an actual distance to the POI and then perform the comparison when performing a pointing of the POI according to the point operation of the user, thereby easily finding the POI designated by a user among a plurality of POIs positioned at different distances.

The above-described subject matter of the present invention is to be considered illustrative and not restrictive, and it should be understood that numerous other modifications and embodiments can be devised by those skilled in the art that will fall within the spirit and scope of the principles of the present invention. Accordingly, the embodiments of the present invention are to be considered descriptive and not restrictive of the present invention, and do not limit the scope of the present invention. The scope of the present invention should be determined by the following claims and their appropriate legal equivalents.

What is claimed is:

1. An augmented reality information providing apparatus, comprising:
a POI information search unit configured to acquire POI information on the basis of position information and gaze direction information of a user;
a distance information acquisition unit configured to acquire an image in a gaze direction of the user and acquire distance information to objects included in the image; and
a control unit configured to compare the objects and the POI, adjust the user position information and the POI information, and provide augmented reality information including the POI information.

2. The augmented reality information providing apparatus of claim 1, wherein the control unit adjusts the position information of the user using the position information of the POI and the distance information to the objects when a feature point of the object and a feature point of the POI are matched over a predetermined level.

3. The augmented reality information providing apparatus of claim 1, wherein the control unit provides the augmented reality information having the size adjusted according to the distance information.

4. The augmented reality information providing apparatus of claim 1, wherein the control unit is configured to convert and then compare relative distance movement of a variety of pointing devices (including a finger) according to a pointing operation into an actual distance to the POI and display a POI indicated by the user among a plurality of POIs positioned at different distances.

5. The augmented reality information providing apparatus of claim 1, wherein the POI information search unit acquires the position information of the user using received GPS information and acquires 3D gaze direction information and height information using a gyro sensor and an altitude sensor.

6. The augmented reality information providing apparatus of claim 5, further comprising a storage unit configured to store the POI information,
wherein the POI information search unit searches the storage unit for the POI stored therein on the basis of the position information and gaze direction information of the user.

7. The augmented reality information providing apparatus of claim 5, further comprising a communication unit configured to communicate with an external server storing the POI information,
wherein the POI information search unit acquires the POI information stored in the external server through the communication unit.

8. The augmented reality information providing apparatus of claim 1, wherein the distance information acquisition unit comprises two cameras, or one camera and one TOF sensor.

9. The augmented reality information providing apparatus of claim 1, further comprising a display unit configured to display the image obtained by the distance information acquisition unit and the augmented reality information provided by the control unit.

10. An augmented reality information selecting and providing method, comprising:
acquiring POI information in a gaze direction of a user on the basis of position information and gaze direction information of the user;
acquiring an image for the gaze direction of the user;
acquiring information about distance to objects included in the image;
comparing the objects and POI to adjust the position information of the user as a result of the comparison; and
providing augmented reality information including the POI information.

11. The augmented reality information selecting and providing method of claim 10, wherein the adjusting of the position information of the user as a result of the comparison comprises adjusting the position information of the user on the basis of the POI position information and the object distance information when a feature point of the object is matched with a feature point of the POI.

12. The augmented reality information selecting and providing method of claim 10, wherein the providing of the augmented reality information including the POI information comprises:
providing the augmented reality information including information about a pointing for indicating the POI; and
converting relative distance movement of a pointing device (including a finger) according to a pointing operation into an actual distance to the POI and then displaying a POI indicated by the user among a plurality of POIs positioned at different distances.
